(19) United States
(12) Patent Application Publication
(10) Pub. No.: US 2012/0032444 A1
(43) Pub. Date: Feb. 9, 2012

(54) Wave Catcher

(76) Inventor: John Alan Burton, Queen Creek, AZ (US)

(21) Appl. No.: 12/851,560

(22) Filed: Aug. 6, 2010

(51) Int. Cl. F03B 13/22

(52) U.S. Cl. 290/53

(57) ABSTRACT

The wave catcher is a wave energy converter comprising three wave energy capture devices: a wave catcher wheel driven by wave particle motion, a wave pressure differential system driven by wave height differential, and a wave amplifier enclosure driven by wave surge; and three auxiliary energy capture devices: wind rotor, water current rotor, and photovoltaic cells all driving a common turbine to generate electricity. It extracts multi-frequency, variable amplitude ocean wave spectral energy and operates on, near, or far from the shoreline. Floats and structure position and orient the wave catcher to take the most advantage of the incident waves.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to ocean energy and more particularly wave energy converters (WEC).

2. Prior Art

The practical solution to the problem of efficiently capturing ocean wave energy, converting the wave energy to a mechanical or electrical form, and transmitting the converted energy without great loss has not been solved. Such a solution, primarily, demands a continuous flow of energy from the wave to the end use. Specifically, it is necessary to attain a greater economy of conversion than has been attained to present, to construct a cheaper, more reliable, and simpler device, and lastly, to overcome the many shortfalls the prior art teaches by way of example of extracting ocean wave energy. The present invention more nearly solves the problem than any device yet conceived.

The idea of extracting energy from ocean waves is not new. Girard, a French inventor, obtained a patent for a machine he and his son had designed in 1799 to capture the energy in ocean waves by attaching wooden beams to docked ships with the use the vessel's bobbing motion to operate the beams as levers against fulcrums on the shore. More than 1500 wave energy patents exist and many advances have been achieved, however, the WEC prior art's history is one of trials and tests followed by disappointment and delays and is littered with failures. Only after the last 30 years or more of research and experimentation has any commercial exploitation of wave energy of significant scale been initiated. Several ocean wave energy conversion devices have been developed but only a few commercial plants have been deployed.

An appreciation for the power of the ocean can be obtained by just looking at waves pounding a beach, inexorably wearing cliffs into rubble and pounding stones into sand. The ocean holds a tremendous amount of untapped energy. Approximately 8,000-80,000 TWh/yr or 1-10 TW of wave energy is in the entire ocean, and on average, each wave crest transmits 10-50 kW per meter. At any one time in an area of ocean, waves of differing height and period may be arriving from more than one direction. However, since waves are neither steady nor concentrated enough, it has not yet been possible to extract and supply wave energy viably. A major problem with designing wave energy converters has been in handling the vast range of power variations in the ocean waves, from approximately an average power per meter of wave front of 50 kW/m and peaking to 10 MW/m (a 1:200 ratio).

The prior art's main disadvantages of extracting wave power are the device's low efficiency, survivability in harsh environments, and energy transmission's high costs. Wave energy is intermittent, low-speed with large forces and the forces do not act in a single direction. This makes energy conversion difficult since most readily available electric generators operate at high and relatively constant speed. This difficulty is further compounded because waves do not have a constant height nor do they have a constant wavelength and consequently a wave capture device must operate efficiently across a wide range of conditions. A recurring problem is that devices underestimate the power of the sea, and are unable to withstand its assault. Constructing devices that can survive the harsh environment of waves without being so over engineered and therefore prohibitively expensive to construct and maintain is a major issue. Multiple barriers exist for ocean energy technologies, such as gaining site permits, the environmental impact of technology deployments, and grid connectivity for transmitting the energy produced. Any form of activity offshore makes electricity production expensive. Another practical problem is the lack of infrastructure to connect wave-energy generators to the power grid. Together the disadvantages have made the cost of extracting wave energy prohibitively high. A cost effective and efficient solution, which also offers a high degree of survivability, and ease of implementation and maintenance for extracting wave power cannot be found in the prior art.

Ocean waves have many aspects to consider when designing a wave energy converter (WEC). Waves are actually a form of energy. Energy, not water, moves along the ocean's surface. Wave water particles only travel in small circles as a wave passes. Waves can range in height from a fraction of a meter to tens of meters and vary in period from seconds to many hours. Wind-generated waves typically have periods from 1 to 25 seconds, wave lengths from 1 to 1000 meters, speeds from 1 to 40 m/s, and heights less than 3 meters. Seismic waves, or tsunamis, have periods typically from 10 minutes to one hour, wave lengths of several hundreds of kilometers, and mid-ocean heights usually less than half a meter. Tides are waves and occur with a period of approximately 12 and a half hours and tidal ranges vary globally and can differ anywhere from near zero to nearly 12 meters. The energy contained in a wave consists of two kinds: the potential energy, resulting from the amplitude displacement of the free surface and the kinetic energy, due to the fact that the water particles throughout the fluid are moving. Water is a dispersive medium with respect to deep water surface waves, in much the same way that it is a dispersive medium for light waves. A deep water wave's speed is not a function of the wave length. Shallow water surface waves, on the other hand, do feel the bottom and slow down in proportion to the square root of the depth. Wave energy is lost by friction with the sea bottom if the water level is half a wavelength of the wave or less. About 80% of the energy in a surface wave is contained within a quarter of a wavelength below the surface. Thus, for a typical ocean wavelength of 100 m, this layer is about 25 m deep. This makes wave power a highly concentrated energy source with much smaller hourly and day-to-day variations than other renewable resources such as wind or solar. In general, the wave power below sea level decays exponentially by a factor of (−2πd/2) where d is the depth below sea level. This property is valid for waves in water with depths greater than λ/2. All the particles of water beneath a surface disturbed by ocean waves are in motion. Wave particles under wave crests move in the direction of wave propagation; particles under wave troughs move against the direction of wave propagation. Water particles move in approximately circular orbits in the vertical plane perpendicular to the crest line of the waves and the radius of the circular path decreases exponentially with depth. All particles take the same periodic time to complete one cycle of their motion but do not all reach the top of their orbits at the same time. At increasing depth as the wave approaches shallower sea floors in relation to the wavelength, the particles move in the elliptical orbits whose major and minor axes both decrease exponentially with depth. The orbits must be completed once every period, move at a constant speed in one direction of rotation, and the diameters of the orbit of particles at the surface must be equal to the wave height. Wave height variations also change the water pressure below the wave.

Likewise, WEC's should be constructed on solid principles. Wave energy impinging on a wave energy converter can be absorbed, reflected, refracted, diffracted, and transmitted. WEC's must maximize energy absorption and should minimize or take advantage of reflection, refraction, diffraction, and transmission losses. WEC's should minimize energy lost in energy conversion processes. Energy is lost in every step of the energy conversion. The lost energy results in less energy delivered of the end use. Many prior art devices use intermediate pneumatic or hydraulic primary power conversion. Loss in the primary energy conversion includes viscous loss in the sea and in valves and pumps, leakage and friction in pumps etc. The instantaneous power absorbed by a WEC is the product of the force and the velocity of the mechanism relative to its point of reaction and the wave's force and velocity should be amplified. Mechanical links in a WEC should be minimized and concentrations of stress should be avoided wherever possible. Reliability of systems will be greatly reduced if moving parts in particular are subject to corrosion by sea water or fouling by marine flora or fauna. Fishing operations are likely to be more adversely affected by a dispersed type of wave power station involving a great many separate units and mooring lines than they would be by a smaller number of larger units. Certain types of WEC systems need protection from severe sea conditions. Although about 60 percent of the energy comes from waves of length 100-200 m, a system should not be highly sensitive to one particular frequency. A free floating off shore station which does not use a connection to the sea bed in its generating mechanism is considered to have a low degree of difficulty in achieving tidal compensation. WEC's should be oriented to absorb maximum directional power spectrum energy that takes advantage of the fact waves of differing height and period may be arriving from more than one direction. Wave energy converters need not be passive. It is possible to capture more energy by actively creating a wave that opposes the incoming wave. WEC's should require a minimum of R & D and should use components currently available. Wave power has the attraction of not requiring very large single investments and use of existing technology stimulates implementation. Generally, the WEC' power output should strive to produce electricity at a steady rate and optimally at times of peak demand. The best zones for setting up wave power are those that lie between 30- and 60-degree latitudes. WEC's should be incredibly durable, modular and decentralized and therefore less vulnerable to damage. Choose a site carefully—not just for its available wave energy. Siting of a WEC should enhance the environment. WEC operation and maintenance personnel skills required should not be demanding. Installation and placement should not require special equipment, tools, or vessels. The most important point to be emphasized with respect to man-made offshore platforms is that they are relatively expensive. Therefore, any non-conflicting multiple-use that can be made of WEC's can help to increase their profitability and defray their capital and maintenance costs. The distance from the WEC to the power take-off, PTO, is a major factor in the viability of a particular installation but will be proportionately less important as the installation size increases. A means of WEC energy storage should be considered to provide smooth energy delivery. Wave forecasting is important to both the operation and the maintenance of offshore systems. Very often access to the installation is restricted by the weather. Access is often not possible in high winds or if using boats in high seas. Include good project management in considering all aspects of waves and the wave energy converter to optimize the local situation. Not following sound principles is why most prior art devices do not exceed 15-20% efficiency. A review of prior art designs shows a lack of consideration of many characteristics of ocean waves and WEC construction or deployment.

Various concepts have been proposed to increase the efficiency of converting wave energy to electric energy using WECs. In some of these systems, the mechanical components of the WECs are “tuned” to have a high efficiency when operating with ocean waves of a specific frequency. Given the narrowband behavior of these systems and the highly variable nature of ocean waves, the overall efficiencies of such systems are poor.

A conventional wave energy conversion system may be on the shore, near shore, or off shore and be of a floating or submerged type. A WEC converts the energy of a wave's pitch, heave, or surge to mechanical or electrical energy. Some use a combination of the wave's heave and surge or heave and pitch.

Types of Wave Energy Converters: Traditionally, wave energy conversion devices have been classified by their placement (on shore, near shore, or offshore/deep water), rather than by the principle of operation of the device or how much energy the device can effectively produce. More recently, WEC devices have begun to be classified by their general method of producing power. The prior art power wave energy conversion devices have been generally classified into the following basic categories, namely:

Point Absorbers: These devices generate electricity from the bobbing or pitching action of a floating object. The object can be mounted to a float or to a device fixed on the ocean floor. They provide a heave motion that is converted by mechanical or hydraulic systems into a linear or rotational motion for driving electrical generators. To generate large amounts of energy, a multitude of these devices must be deployed, each with its own piston and power take-off equipment. Additionally, to absorb reasonable amounts of wave energy the point absorber must undergo large displacements, which can pose particular difficulties for power take-off systems. These mechanical pumping systems suffer from the “end-stop” problem where large destructive forces can be experienced during extreme storms when the pumps may reach the end of their travel violently, with a resulting failure of the systems. The energy extraction relies largely on the wavelength of the incident waves. The point absorber must also cope with a control strategy to bring the device's motion in resonance with the waves so as to maximize energy capture while limiting movement when encountering extreme wave conditions. They must be large or deployed in massive numbers to produce any appreciable power.

Oscillating Water Columns (OWC): These shore devices generate electricity from the wave-driven rise and fall of water in a shaft. The rising and falling water column drives air in and out of the shaft, powering an air-driven turbine. The air chamber within the OWC housing must be designed with the wave period, significant wave height, and wave length characteristics of the local ocean climate in mind. If the housing is not sized correctly, waves could resonate within the air chamber. This resonating effect causes a net zero passage of air through the turbine. Siting these devices is a problem and they are large, expensive to construct, and inefficient. Few sites are appropriate for these devices and they must be built near the local grid to deliver the power produced.

Focusing Devices (Overtopping): These devices, also called “tapered channel” or “tapchan” systems, rely on a structure to channel and concentrate the waves, driving them into an elevated reservoir. Water flow of this reservoir is used to generate electricity using standard hydropower technologies. The combination of low tidal range and naturally occurring reservoir limits the useful potential of this device. Such devices experience a much less powerful wave regime because of loss of wave energy lost elevating the water.

Moving Body Devices—Attenuators and Terminators: A WEC is called an attenuator if it is aligned along the wave direction and a terminator if it lies across the prevailing direction of wave propagation. The relative movement of different parts of the device is driven by the waves to generate pressure in a working fluid. The working fluid might be sea water or hydraulic oil held in a sealed tank which is then passed through a turbine to generate electricity. These are complex machines riddled with valves, filters, tubes, hoses, couplings, bearings, switches, gauges, meters and sensors. The intermediate stages reduce efficiency, and if one component breaks, the whole device goes kaput. The device's cost of generating power is comparatively high to conventional power generation. The absorbtion device presents only a small cross-section to incoming waves, and absorbs less and less energy as the waves get bigger. Most of the time, the devices will not be operating in stormy seas—and when a storm does occur—their survival is more important than their power output.

Prior art devices although different in operation and construction represent the closest to the present invention:

The Archimedes Wave Swing, U.S. Pat. No. 5,808,368 to Brown is a point absorber with a cylinder shaped buoy, fastened to the seabed. Passing waves move an air-filled upper casing against a lower fixed cylinder, with up and down movement converted into electricity. The floater compresses gas within the cylinder to balance pressures. The present invention uses passing waves to generate pressure differentials but it does not use gas compression.

The Oyster, U.S. Pat. No. 20080191485 to Whittaker and others is a terminator that consists of an oscillating wave surge converter is fitted with double acting water pistons fixed to the seabed and deployed near shore. Each passing wave activates the pump; which delivers high pressure water via a sub-sea pipeline to the shore. Onshore, high-pressure water is converted to electrical power using conventional hydro-electric generators. The present invention uses wave surge but does not use pistons or pumps as an intermediate stage in delivering energy.

The PowerGin. U.S. Pat. No. 7,586,207 to Sack uses overtopping wave energy conversion technology to rotate a dual rotor system and convert wave energy directly into continuous rotary motion. It also captures a significant amount of horizontal kinetic energy contained in the wave by using a wave ramp. The wave ramp re-directs forward water movement into a cresting wave which contributes to turning the rotors. The present invention converts wave energy directly into continuous rotary motion but does not use overtopping wave energy to drive the rotation.

The Wave Dragon, Danish patent No. PR 173018 to Friis-Madsenis is an offshore wave energy converter of the overtopping type utilizing a wave reflector design to focus the waves towards a ramp, and the overtopping is used for electricity production through a set of Kaplan/propeller hydro turbines. The present invention focuses waves into a chamber but does uses the wave surge energy and does not use wave over-topping energy extraction.

The Wavemaster, WIPO Patent Application WO/2003/078831 and co-pending British Patent Application GB-A-9920714.4, to Southcombe is a WEC that uses wave pressure differential between containers driving a turbine separating the containers. The containers maintain a high pressure and low pressure side with an array of one-way valves. The present invention's pressure containers alternate between high and low pressure while maintaining continuous flow through the turbine. The present invention's benefit over the Wavemaster is the containers can be separated by a distance to take advantage of pressure differentials. The present invention also uses less material with a smaller structure and two one-way valves per container versus an array of valves.

Syphon wave generator, U.S. Patent No. 20070222222 to Cook is a horizontal pipe with one or more pipes at each end extending down below the water surface and waves passing under the unit cause different water levels at different pipes creating a siphon and water flow between pipes spins the turbine. The present invention uses pressure differential flow in pipes but does not use a siphon principle to initiate the flow.

The present invention solves a long-felt need the prior art has failed to produce, namely; a scalable, highly efficient, and inexpensive wave energy converter. It also solves an unrecognized problem of turning a rotor directly from surface waves' force normal to the waves propagation and omits inefficient intermediate power conversion stages. Contrary to prior art's teaching, an unappreciated advantage of continuous operation and high energy transfer is made by incorporation of a combination of efficient wave energy capture devices instead of one inefficient device. The employment of the usual devices for extracting wave energy; buoys, air or hydraulic compression chambers, and pumps, introduce complexity and inefficiency and adds to the cost of production and maintenance required for the device. Another aspect not suggested in the prior art is direct wave pressure differences between widely separated containers turning a rotor. A synergy is achieved with the present invention that has never been conceived. The present invention is not like any prior art devices that have intermediate pneumatic or hydraulic power transfer stages that must convert the wave energy to an intermediate form prior to extraction.

The following is a full, clear, and exact invention description of a useful, new, and unobvious improvements of wave energy converters not found in prior art.

### SUMMARY

The present invention is a wave energy converter that combines three novel primary wave energy extraction devices that convert wave energy directly into rotary mechanical motion: a wave catcher wheel relies on wave particle motion, a differential pressure system operates on a wave amplitude pressure differential, and a wave amplifier uses the wave surge to focus surface wave's energy. The utility of the device is the ability to use the wave energy to turn a wheel that can drive a propeller, pump, or generator. The wave wheel possesses the unobvious aspect of turning a shaft across the prevailing direction of wave propagation by water particle motion. The differential pressure system possesses the unobvious aspect of turning a shaft by pressure differences between widely separated containers caused by the wave in the same body of water to drive a shaft. The wave amplifier possesses the unobvious aspect of turning a shaft by direct wave surge. Working together they take advantage of both the potential energy of the wave's varying amplitude and the kinetic energy in the wave's movement and transform the energy into mechanical and electrical form. Floats and fins position and orient the wave catcher to take the most advantage of the incident waves. Three auxiliary energy extraction means are provided: a wind turbine, a water current turbine, and a photovoltaic system.

### BRIEF DESCRIPTION OF THE DRAWINGS

### Figures

For a more complete understanding of the present invention and the advantages thereof, reference is now made to the following description taken in conjunction with the accompanying drawings in which:

FIG. 1 is a perspective view of a wave catcher wave energy conversion device;

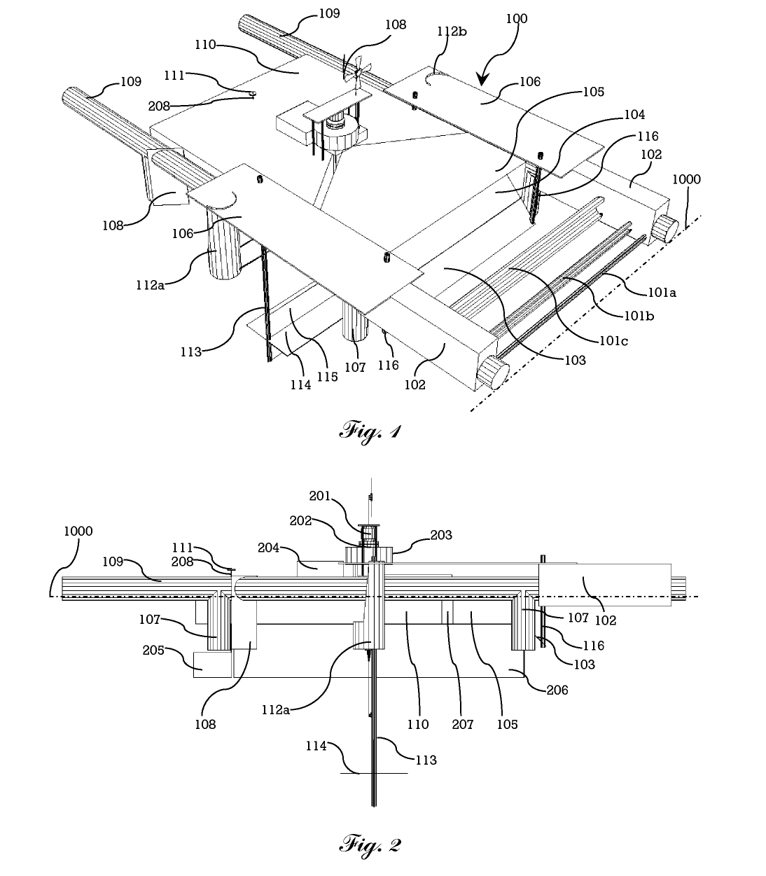

FIG. 2 is a side view of a wave catcher wave energy conversion device;

FIG. 3 is a front view of a wave catcher wave energy conversion device;

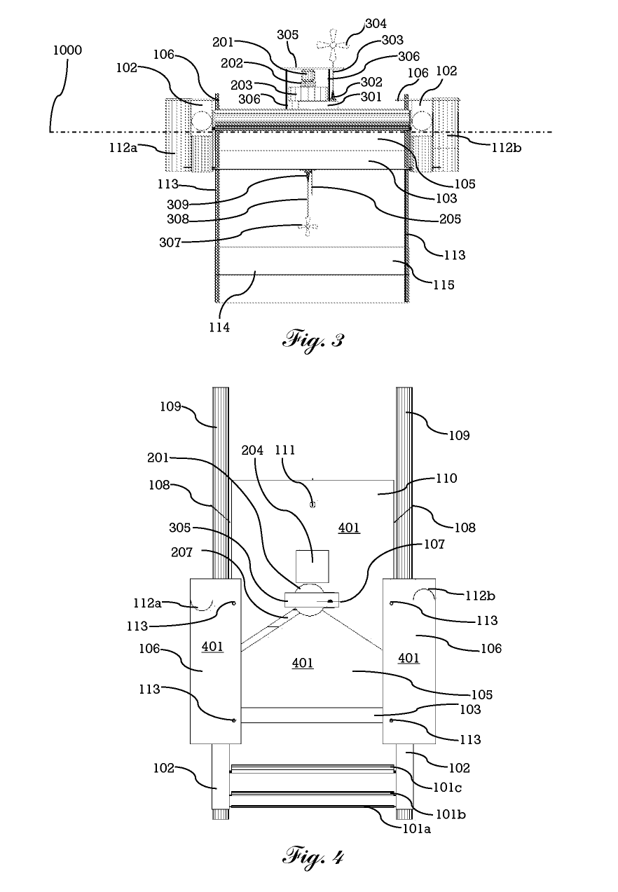

FIG. 4 is a top view of a wave catcher wave energy conversion device;

FIG. 5 is a perspective view of a wave catcher wheel assembly;

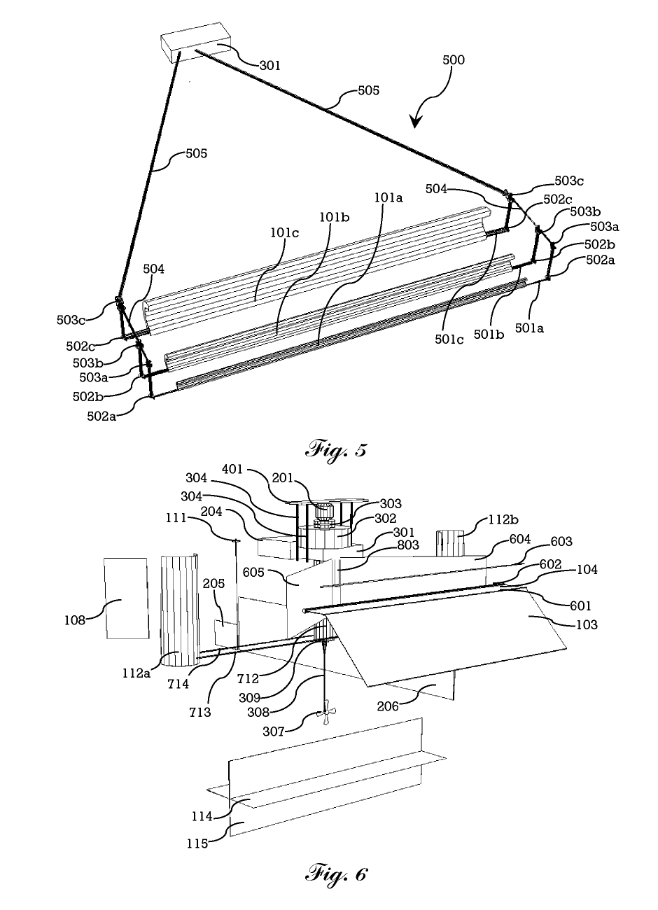

FIG. 6 is a perspective view of an internal structure of a wave catcher wave energy conversion device;

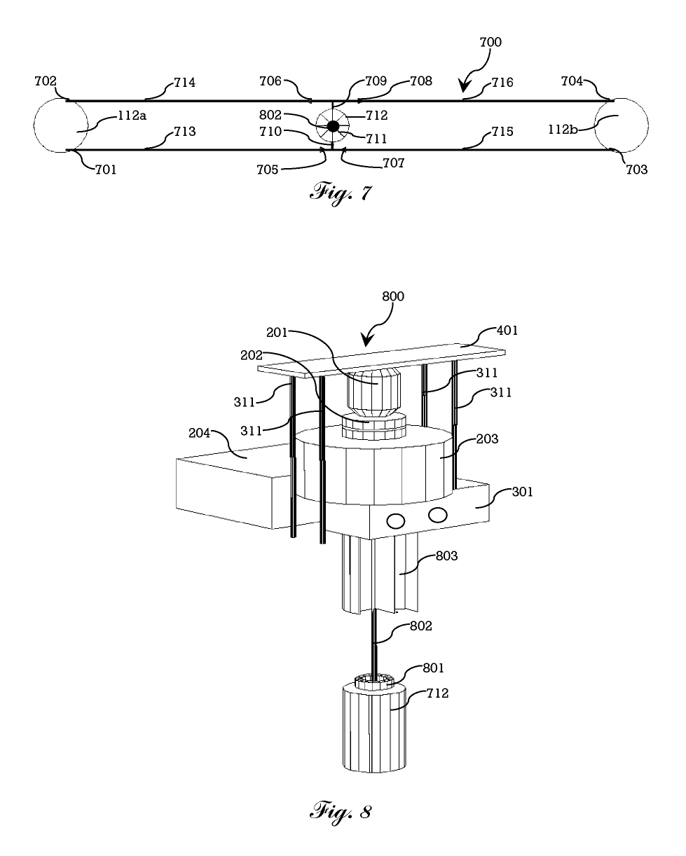

FIG. 7 is top view of a wave pressure differential assembly of a wave catcher wave energy conversion device;

FIG. 8 is a perspective view of a power take off assembly of a wave catcher wave energy conversion device;

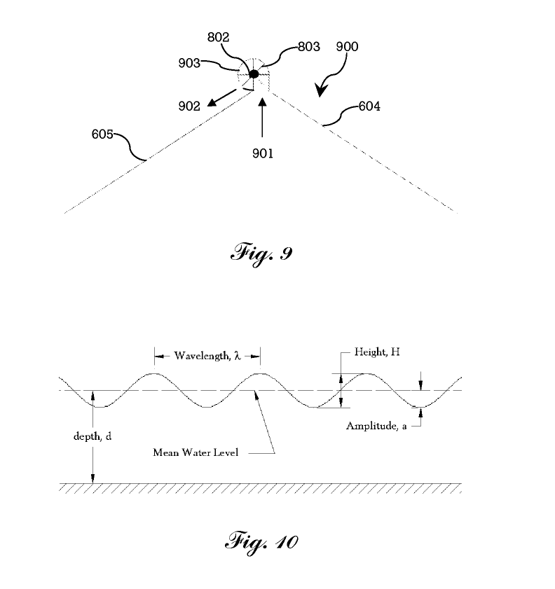

FIG. 9 is a top view of a wave amplifier and turbine of a wave catcher wave energy conversion device;

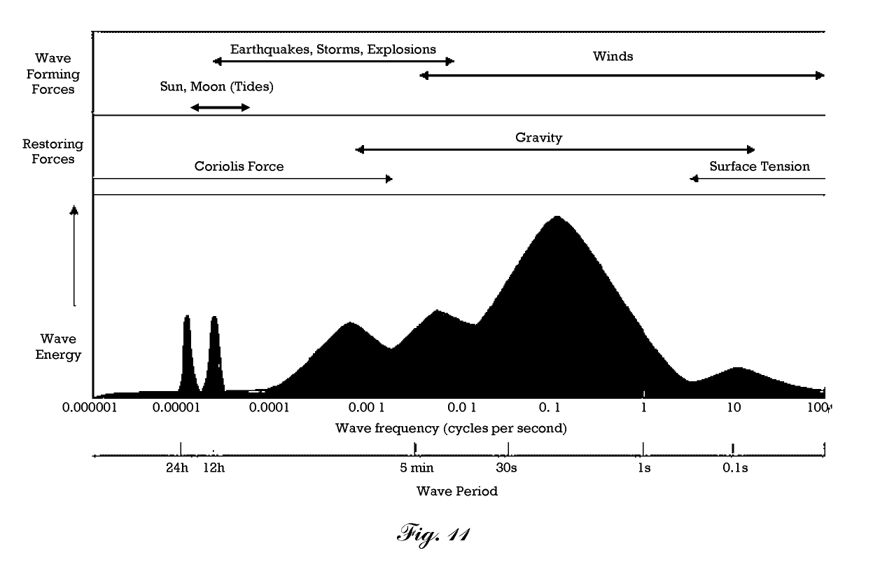

FIG. 10 is a representation diagram of terms defining a wave;

FIG. 11 is a chart of wave energy spectrum;

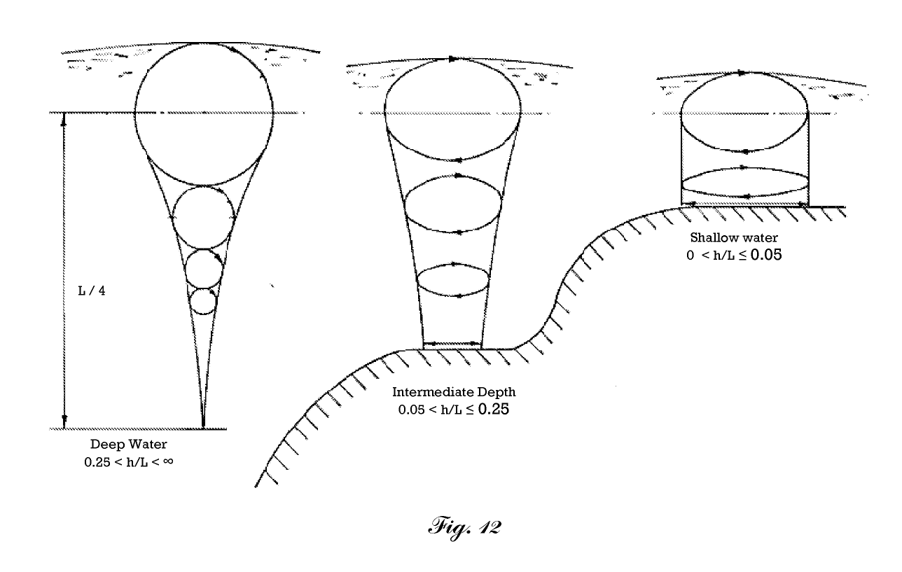

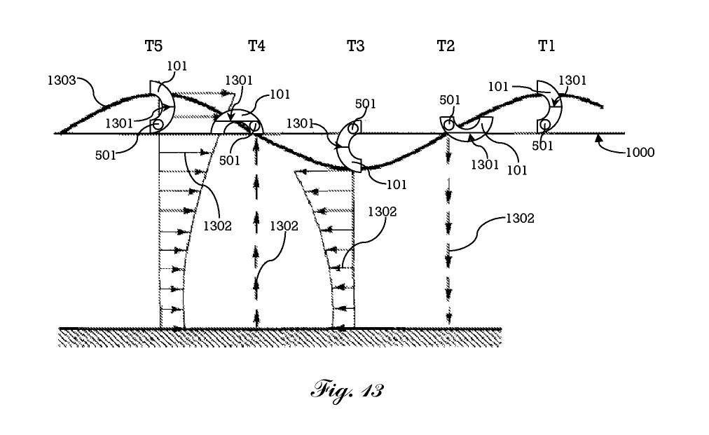

FIG. 12 is a representation of water particle movement at depth;

FIG. 13 is a diagram of a wave catcher wheel in relation to wave particle movement and forces during a wave cycle;

### REFERENCE NUMERALS

Parts contained in the figures are referenced with the following numerals:
Item 100 a wave catcher wave energy conversion device;
Item 101 a wave catcher wheel;
Item 101a a front wave catcher wheel;
Item 101b a middle wave catcher wheel;
Item 101c a back wave catcher wheel;
Item 102 a bevel gear compartment;
Item 103 a wave catcher ramp;
Item 104 a wave catcher entry door;
Item 105 front wave catcher frame;
Item 106 a side mounting bar;
Item 107 a vertical float leg;
Item 108 a back fin;
Item 109 a horizontal float;
Item 110 a back wave catcher frame;
Item 111 a rudder steering wheel;
Item 112a a pressure differential cylinder facing the back;
Item 112b a pressure differential cylinder facing the front;
Item 113 a stabilizer mounting bar;
Item 114 a horizontal stabilizer;
Item 115 a vertical stabilizer;
Item 116 a support bar;
Item 201 an electrical generator;
Item 202 a clutch assembly;
Item 203 a flywheel assembly;
Item 204 an electrical transformer and power electronics assembly;
Item 205 a rudder;
Item 206 a wave orientation fin;
Item 207 a water outlet draft;
Item 208 a rudder shaft;
Item 301 a transmission assembly;
Item 302 a wind turbine clutch assembly;
Item 303 a wind turbine mast axle assembly;
Item 304 a wind turbine rotor;
Item 305 a top generator support bar;
Item 306 a generator support vertical support bar;
Item 307 a water current rotor;
Item 308 a water current rotor axle;
Item 309 a water current rotor clutch assembly;
Item 401 a photovoltaic covered surface;
Item 500 a wave catcher wheel assembly;
Item 501 a freewheel axle;
Item 501a a freewheel axle;
Item 501b a freewheel axle;
Item 501c a freewheel axle;
Item 502a a bevel gear assembly;
Item 502b a bevel gear assembly;
Item 502c a bevel gear assembly;
Item 503a a bevel gear assembly;
Item 503b a bevel gear assembly;
Item 503c a bevel gear assembly;
Item 504 a connecting bevel gear axle;
Item 505 a connecting bevel gear to transmission axle;
Item 601 a wave catcher door hinge;
Item 602 a wave catcher door float;
Item 603 a wave catcher entry door stop;
Item 604 a wave amplifier right wall;
Item 605 a wave amplifier left wall;
Item 700 a pressure differential turbine assembly;
Item 701 a pressure differential outlet port;
Item 702 a pressure differential inlet port;
Item 703 a pressure differential outlet port;
Item 704 a pressure differential inlet port;
Item 705 a one way flow check valve;
Item 706 a one way flow check valve;
Item 707 a one way flow check valve;
Item 708 a one way flow check valve;
Item 709 a pressure differential turbine output pipe;
Item 710 a pressure differential turbine inlet pipe;
Item 711 a pressure differential turbine wheel;
Item 712 a pressure differential turbine case;
Item 713 a pressure differential output pipe;
Item 714 a pressure differential input pipe;
Item 715 a pressure differential output pipe;
Item 716 a pressure differential input pipe;
Item 800 a wave catcher power take off assembly;
Item 801 a differential turbine bearing;
Item 802 a power takeoff freewheel axle;
Item 803 a wave amplifier turbine wheel;
Item 900 a wave amplifier turbine assembly;
Item 901 a wave amplifier turbine inlet port;
Item 902 a wave amplifier turbine outlet port;
Item 903 a wave amplifier turbine housing;
Item 1000 mean sea level;
Item 1301 wave catcher wheel internal water level;
Item 1302 wave water particles directional movement;
Item 1303 a wave;

### DETAILED DESCRIPTION

### Static Physical Structure—First Embodiment

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

With reference to FIG. 1, a wave energy conversion device 100 in accordance with the preferred embodiment is shown and is collectively referred to as a wave catcher. The wave catcher 100 includes three wave catcher wheels 101 of different sizes 101a, 101b, and 101c. Wave catcher wheels 101a, 101b, or 101c are hollow axially divided cylindrical shell filled with half air and half water that rotate on a freewheel axle 501a, 501b, or 501c, respectively depicted in FIG. 5. The wave catcher wheels 101a, 101b, or 101c are attached to a bevel gear compartment 102. A wave catcher ramp 103 is attached to a front wave catcher frame 105 and is supported by a pair of front support bars 116. A buoyant wave catcher entry door 104 is hinged to the front wave catcher frame 105. A side mounting bar 106 is connected to a pair of rear support bars 113 and a pair of front support bars 116, a bevel gear compartment 102, and a rear facing pressure differential cylinder 112a, and a front facing pressure differential cylinder 112b. A vertical float leg 107 attaches to a horizontal float 109. A back fin 108 is attached to a back wave catcher frame 110 and the horizontal float 109. A rudder wheel 111 is connected to a rudder shaft 208. A horizontal stabilizer 114 and a vertical stabilizer 115 are perpendicular to each other and are supported by a stabilizer mounting bar 113.

With reference to FIG. 2, an electrical generator 201 connects to a clutch assembly 202 and the clutch assembly connects to a flywheel 203. A transformer 204 is mounted to the back wave catcher frame 110. A rudder 205 attaches to the rudder shaft 208. A wave orientation fin 206 attaches to the underside of the front wave catcher frame 105 and back wave catcher frame 110. A water outlet draft 207 is between one side of the front wave catcher frame 105 and back wave catcher frame 110.

With reference to FIG. 3, a transmission assembly 301 attaches to the flywheel 203. A wind turbine rotor 304 connects to a wind turbine mast axle assembly 303 that supports a wind turbine rotor 304. A top generator support bar 305 attaches to a generator support vertical support bar 306 and generator 201. A water current rotor clutch assembly 309 attaches to a water current rotor axle 308. A water current rotor attaches 307 to the water current axle 308.

With reference to FIG. 4, a photovoltaic surface 401 is on the front wave catcher frame 105 and back wave catcher frame 110 and the side mounting bar 106.

With reference to FIG. 5, a wave catcher wheel assembly 500 comprising a front wave catcher wheel 101a supported by a freewheel axle 501a, wave catcher wheel 101b supported by a freewheel axle 501b, and wave catcher wheel 101c supported by a freewheel axle 501c. Freewheel axle 501a, 501b, and 501c connect to a bevel gear assembly 502a, 502b, and 502c, respectively. Bevel gear assembly 502a, 502b, and 502c connect to bevel gear assembly 503a, 503b, and 503c, respectively. A bevel gear axle 504 connects to bevel gear assemblies 503a, 503b, and 503c. A connecting bevel gear to transmission axle 505 connects to bevel gear assembly 503c and transmission 301

With reference to FIG. 6, a wave catcher door hinge 601 attaches to the front wave catcher frame 105 and a wave catcher door 104. A wave catcher door float 602 attaches to the wave catcher door 104. A wave catcher door stop 603 ends connect to the front wave catcher frame 105. A wave amplifier right wall 604 is between front wave catcher frame 105 and back wave catcher frame 110. A wave amplifier left wall 605 is between the front wave catcher frame 105 and the water outlet draft 207.

With reference to FIG. 7, A top view of a pressure differential turbine assembly 700 is shown. A pressure differential cylinder facing the back 112a having a pressure differential outlet port 701 and a pressure differential inlet port 702 and a pressure differential cylinder facing the front 112b having a pressure differential outlet port 703 and a pressure differential inlet port 704. A pressure differential output pipe 713 is between the pressure differential outlet port 701 and a one way flow check valve 705. A pressure differential output pipe 715 is between the pressure differential outlet port 703 and a one way flow check valve 707. A pressure differential input pipe 714 is between the pressure differential intlet port 702 and a one way flow check valve 706. A pressure differential input pipe 716 is between the pressure differential inlet port 704 and a one way flow check valve 708. A pressure differential turbine inlet tee pipe 710 is connected between check valves 705 and 707 and the inlet port of a pressure differential turbine case 712. A pressure differential turbine outlet tee pipe 709 is connected between check valves 706 and 708 and the inlet port of a pressure differential turbine case 712. A pressure differential turbine wheel 711 is contained by the pressure differential turbine case 712.

With reference to FIG. 8, a power take off assembly 800 is shown. A differential turbine bearing 801 is connected between the pressure differential turbine case 712 and the back wave catcher frame 110. A power take off freewheel axle 802 is connected to the water current rotor clutch assembly 309 through pressure differential turbine wheel 711 and the wave amplifier turbine wheel 804 to the transmission assembly 301.

With reference to FIG. 9, a wave amplifier turbine assembly 900 is shown with an inlet port 901 and an outlet port 902. A wave amplifier turbine housing 903 contains the wave amplifier turbine 802.

With reference to FIG. 13, the wave catcher wheel 101 is superimposed on a wave 1303 referenced to mean sea level 1000 and shows the wave wheel internal water level 1301 at times T1, T2, T3, T4, and T5.

The wave catcher 100 structure can be constructed of any rigid materials. Preferably, the materials should be non-corrosive in seawater and durable in a harsh environment. The wave catcher 100 dimensions are determined by the aspects of the site chosen and the amount of power sought to capture and convert. The wave catcher 100 power capture range could be as low as a few watts to as high as multiple gigawatts.

### Operation

The embodiments depend on where the wave energy converter is sited. The preferred embodiment is a site where the three wave power conversion assemblies; wave catcher wheel 500, wave pressure differential 700, and wave amplifier 900, and the three auxiliary power conversion devices; wind turbine rotor 304, water turbine rotor 307, and photovoltaic surface 401 capture the most power. An optimum site would have a strong wave regime, be deep enough to accommodate the device, have an underwater current, be sunny and windy on most days, and be close to a power load. Power extraction could be obtained from any one of the energy capture methods independently and all are not required simultaneously. The essence of the embodiment is the use from one to three different wave energy extraction methods and one to three auxiliary power extraction methods to deliver the most power for the end application. The preferred embodiment operation will now be described when it is located at an optimum site.

With reference to FIG. 1, the construction materials of the wave catcher 100 will determine the weight of the device and vertical floats 107, horizontal floats 109, internal water level of the back frame assembly 110, and bevel gear compartment 102 buoyancy will be adjusted so the mean sea level 1000 is level with the water wheel axles 501a, 501b, and 501c depicted in FIG. 5 and the wave catcher door hinge 601 depicted in FIG. 6. Stabilizer mounting bars 113 support horizontal stabilizer 114 and vertical stabilizer 115. The stabilizers 114 and 115 counteract the pitching motion caused by a wave impinging on the wave catcher 100. Back fins 108, wave orientation fin 206, and rudder 205 all assist in aligning the wave catcher 100 front toward the direction of a approaching wave.

With reference to FIG. 3, an auxiliary wind power turbine comprising the wind turbine rotor 304, wind turbine mast axle assembly 303, and wind turbine clutch assembly 302 and an auxiliary water current power turbine comprising the water current rotor 307, water current rotor axle 308, and water current rotor clutch assembly 309 are shown. A wind impinges on and turns the wind turbine rotor 304 that is coupled to and rotates the wind turbine mast axle assembly 303 that connects to one side of the wind turbine clutch assembly 302. The wind turbine clutch assembly 302 engages and rotates gears within the transmission assembly 301. A water current impinges on and turns water current rotor 307 that is coupled to and rotates water current rotor axle 308 that connects to one side of the water current rotor clutch assembly 309. The water current rotor clutch assembly 309 engages and drives power takeoff freewheel axle 802.

With reference to FIG. 4, an auxiliary power generating system comprising a photovoltaic covered surface 401 is shown. The photovoltaic cells are connected to the electrical transformer and power electronics assembly 204.

With reference to FIG. 5, a plurality of wave catcher wheels 101a, 101b, and 101c revolve on their respective freewheel axles 501a, 501b, and 501c. The freewheel axles 501a, 501b, and 501c rotate their respective coupled bevel gear assemblies 502a and 503a, 502b and 503b, and 502c and 503c. Connecting bevel gear axles 504 rotation with the bevel gear assemblies 503a, 503b, and 503c rotate the connecting bevel gear to transmission axle 505. Bevel gear to transmission axle 505 is coupled to and rotates gears within transmission assembly 301. Three wave catcher wheels 101a, 101b, and 101c of different sizes are shown. More wave catcher wheels 101 could be added in series toward the incoming waves. The size of wave catcher wheel 101 can vary widely but depends on the size of the wave it is designed to capture. A small wave catcher wheel 101 in relation to the impinging wave fully rotates the wave catcher wheel 101 a full rotation. A large wave catcher wheel 101 in relation to the impinging wave will partially rotate the wave catcher wheel 101 and all subsequent wave oscillating movement will add torque to freewheel axle 501 when the freewheel axle 501 engages during the designed direction of rotation. Any rotation of any wave catcher wheel 101 as a result of wave action is additive. Many wave catcher wheels 101 of various sizes will capture the most energy in a varying wave regime. Each wave catcher wheel 101 rotates its respective freewheel axle 501 when the wave catcher wheel's 101 rotation speed is greater than the freewheel axle's 501 speed.

With reference to FIG. 6, the wave catcher ramp 103 along with wave amplifier right wall 604, wave amplifier left wall 605, and front wave catcher frame 105 of FIG. 1 concentrate an incoming wave's surge energy and funnel the wave's energy to drive the wave amplifier turbine wheel 803. The wave catcher ramp 103 is below the mean sea level and projects at an angle under and into the oncoming waves. During wave crests, waves move up the wave catcher ramp 103 and over wave catcher entry door 104. The wave continues into the wave catcher 100 and impinges on wave amplifier right wall 604 and wave amplifier left wall 605 that restricts the volume and thereby increases the wave's amplitude and velocity. The amplified wave then drives the rotation of wave amplifier turbine wheel 803 at the vertex. A reflected wave results after the initial surge reaches the wave amplifier turbine wheel 803. The reflected wave moves back toward the wave catcher entry door 104. The wave catcher entry door 104 along with the wave catcher entry door float 602 are buoyant and rotate up as a result of the reflected wave's increase water level height. Wave catcher entry door stop 603 stops the door from rotating and thereby captures the water to prevent it from exiting the wave catcher 100. This action acts like a check valve to allow the water in and maintains a head to drive the wave amplifier turbine wheel 803.

With reference to FIG. 7, the top view of the pressure differential turbine assembly 700 is shown. The pressure differential cylinder facing the front 112b and pressure differential cylinder facing the back 112a will have different water levels within their volumes as a result of wave action. This difference in water level creates a differential pressure between them that induces a water flow to drive the pressure differential turbine wheel 711. Pascal's principle states a pressure exerted anywhere in a confined liquid is transmitted equally and undiminished in all directions throughout the liquid. If pressure differential cylinder facing the front 112b has a greater water level than pressure differential cylinder facing the back 112a, water flows out of pressure differential cylinder facing the front 112b through pressure differential outlet port 703, pressure differential output pipe 715, one way flow check valve 707, pressure differential turbine inlet pipe 710, pressure differential turbine wheel 711, pressure differential turbine output pipe 709, one way flow check valve 706, pressure differential input pipe 714, pressure differential inlet port 702, and into pressure differential cylinder facing the back 112a. If pressure differential cylinder facing the back 112a has a greater water level than pressure differential cylinder facing the front 112b, water flows out of pressure differential cylinder facing the back 112a through pressure differential outlet port 701, pressure differential output pipe 713, one way flow check valve 705, pressure differential turbine inlet pipe 710, pressure differential turbine wheel 711, pressure differential turbine output pipe 709, one way flow check valve 708, pressure differential input pipe 716, pressure differential inlet port 704, and into pressure differential cylinder facing the front 112b. Both flows produce one way flow through and rotation of pressure differential turbine wheel 711. Pressure differential turbine wheel's 711 rotation drives power take-off freewheel axle 802.

With reference to FIG. 8, the power take-off assembly 800 aggregates the collected mechanical energy of the wave catcher wheel assembly 500, pressure differential turbine assembly 700, wave amplifier turbine assembly 900, water current rotor 307, and wind turbine rotor 304; transmission assembly 301 couples the torque forces and increases the speed of the mechanical rotation; flywheel 203 smoothes and stores the mechanical rotation; clutch assembly 202 transfers the mechanical rotation to drive the generator 201; generator 201 generates electricity; and electrical transformer and power electronics assembly 204 conditions the electrical energy for transmission.

With reference to FIG. 9, the wave amplifier turbine assembly 900 is shown from a top view. The incoming water enters through wave amplifier turbine inlet port 901, turns wave amplifier turbine wheel 803 revolving on power takeoff freewheel axle 802, and exits wave amplifier turbine outlet port 902.

With reference to FIG. 13, I believe I am the first to show a device that can continuously turn an axle from the wave propagation acting perpendicular to the device across the prevailing direction of wave propagation. The wave catcher wheel 101 continuously rotates on wave catcher freewheel axle 501. Three forces produce the continuous rotation; gravity acting on the contained liquid in the wave catcher wheel 101, buoyancy of the gas in the wave catcher wheel 101, and the force of the wave water particles movement 1302 impinging on the wave catcher wheel 101. FIG. 13 shows a complete wave catcher wheel 101 cycle of rotation and the wave catcher wheel 101 orientation is depicted at times T1, T2, T3, T4, and T5. Wave catcher axles 501( ) maintains their vertical position relative to an incident wave and the wave catcher wheel 101 revolves around it. Times T1 and T5 are at the wave crest and the circular movement of the wave particles 1302 continuously push the wave catcher wheel 101 to orientations depicted at times T1, T2, T3, T4, and T5. The wave catcher wheel 101 makes one complete rotation in one wave wavelength. Any shape that provides resistance to the circular water particle movement could be used to turn the axles 501( ) but a cylindrical shape provides the largest advantage. The cylindrical shape also has the benefit of having a large coefficient of drag difference between the inside and outside of the wave catcher wheel 101. An inward concave surface provides more drag and an outer convex surface offers less drag to the wave catcher wheel 101 as it rotates about its freewheel axle 501. The wave catcher wheel 101 will also work below the wave surface to the level where wave particle movement is still present but works best near the surface where water particle movement is greatest.

One skilled in the art will appreciate what is not depicted or specified in the diagrams that have had a long history of development and the many possible variations in construction techniques used. The structure can be made of many rigid materials and the connection method or devices used to connect the structure are dependent on the construction materials. Gearing and gearing control and engagement methods are abundant in prior art. Mooring is not shown because the device could be anchored at the shore, attached to slack mooring if operated near shore, or have no mooring if operated off shore.

### Operation

### Alternative Embodiments

One skilled in the art will recognize the many possible embodiments of the present invention. The wave catcher wheel assembly 500, pressure differential turbine assembly 700, and wave amplifier turbine assembly 900 could be used together, individually, or in any combination. Also, the three auxiliary energy extraction devices; the wind turbine consisting of the wind turbine rotor 304, wind turbine mast axle assembly 303, and wind turbine clutch assembly 302, water current turbine consisting of water current rotor 307, water current rotor axle 308, water current rotor clutch assembly 308; and photovoltaic surface 401 need not be used at all or could be used together, individually, or in any combination. Siting will largely determine the devices used.

Some examples of possible embodiments are described. If a shore site was chosen that required no visible component in the waves, the wave catcher wheel assembly 500 could be used alone projecting from the shore and under the surface. If a site was chosen to use the device as a breakwater, a water amplifier turbine 900 could be used alone. If a site was chosen using an existing structure such as a pier or oil drilling rig, the pressure differential turbine assembly 700 could be used alone. The flexibility of configuring the wave catcher power take off assembly 800 makes the many embodiments possible.

### CONCLUSION, RAMIFICATIONS, AND SCOPE

It will be appreciated by those skilled in the art having the benefit of this disclosure of the many embodiments that provides a wave energy conversion system. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments. The specification contains a description of the invention, and of the manner and process of making and using it, in such full, clear, concise and exact terms as to enable any person skilled in the art of wave energy converters, or with which it is most nearly connected, to make and use the same, and sets forth the best mode contemplated of carrying out the invention.

The wave catcher extracts a large portion of wind-generated waves and a significant portion of the energy of all wave lengths and wave heights. The wave catcher exploits the total energy contained in a wave; both the potential energy of wave height and the kinetic energy of wave movement. The wave catcher can accommodate a large range in wave heights and from varying wavelengths and self-orients in the direction of oncoming waves. The wave catcher focuses on the concentrated wave energy near the water's surface. It operates continuously on wave power by concentrating the energy source with much smaller variations than other wave energy converters.

The wave catcher is grounded on solid principles. It maximizes the wave energy absorbed impinging on it and it minimizes reflection, diffraction, and transmission losses. The wave catcher is designed to increase the instantaneous power absorbed by amplifying the force and the velocity of the wave energy. Mechanical links are minimal and concentrations of stress are virtually eliminated. Reliability is greatly enhanced because the wave catcher has few moving parts subject to corrosion by sea water or fouling by marine flora or fauna. Fishing operations are not likely to be adversely affected by the wave catcher because a small number of larger units only need to deploy to capture large amounts of energy. The wave catcher can withstand severe sea conditions. It is not highly sensitive to one particular frequency but operates well over a large range. It can be free floating which does not use a connection to the sea bed in its generating mechanism and has no difficulty in achieving tidal compensation. The wave catcher is self-oriented to absorb maximum directional power spectrum energy and it takes advantage of the fact waves of differing height and period may be arriving from more than one direction. The wave catcher wave energy converter is not passive and captures more energy by actively creating a wave that opposes the incoming wave. Minimal R & D is required to configure components per specific sites chosen and components are available off-the-shelf or easily constructed. No large investments are needed to rapidly implement a project. The wave catcher's power output produces electricity at a steady rate. The wave catcher is incredibly durable, modular and decentralized and therefore less vulnerable to damage. The sitting of a wave catcher will enhance the environment since it can be sited to counteract beach erosion and poses very minimal risk to fish. Operation and maintenance is simple and minimal personnel skills are needed. It can propel be easily transported to the location it has been sited for without need of special tools or vessels. The wave catcher can provide many non-conflicting multiple-uses like breakwaters, water pumping near shore based power plants and in fish farming, ship propulsion, or power generation for oil and gas offshore installations. It can augment off shore wind power generating facilities. The wave catcher will have a large utilization factor for wave power—the ratio of yearly energy production to the installed power of the equipment—is typically 2 times higher than that of wind power. That is whereas for example a wind power plant only delivers energy corresponding to full power during 25% of the time (i.e. 2,190 h out of the 8,760 h per year) a wave power plant is expected to deliver 50% (4,380 h/year). The power take off is built in and requires no hydraulic or electrical intermediate conversion stages. A means of flywheel energy storage is incorporated for continuous smooth power delivery. The wave catcher can operate unattended and can withstand high winds and high seas. The wave catcher can be easily and rapidly adjusted to optimize the local situation of waves and takes advantage of ocean waves characteristics in a unique and unobvious way.

The wave catcher could be used to power desalination plants, hydrogen or ammonia production applications. The power scale could range from driving a single pump to providing the complete electricity demands of countries. On massive scales, it could mitigate hurricanes by pumping cool water at depth to the surface or protect and provide electricity to coastal cities while attenuating the storm surge. At global scales, it could provide power to propel vessels across oceans.

What I claim as my invention is:

1. A device for converting wave energy into rotational mechanical energy called a wave catcher wheel, comprising:
(a) a resistive surface to wave particle movement attached at one side to
(b) an axle of rotation across the prevailing direction of wave propagation supported by
(c) bearings whereby the position of said axle is maintained by
(d) a support structure in a wave medium at a predetermined water level to permit unobstructed rotation of the resistive surface about the axle which connects to and drives
(e) gears.

2. A wave catcher wheel of claim 1 further comprising:
a wave particle movement resistive surface formed into a sealed hollow half cylinder shell and is filled with a predetermined level of liquid and air.

3. A device for converting wave energy in into rotational mechanical energy called a pressure differential turbine, comprising:
(a) a plurality of vessels positioned below the surface of a wave medium and open to the wave medium at the top with inlet and outlet port openings below the top and connected respectively to;
(b) pressure differential pipes that have
(c) one-way flow valves that route to
(b) a turbine container port openings between the plurality of vessels whereby a water pressure differential between the vessels drives;
(b) a turbine.

4. The device of claim 3 further comprising:
a plurality of vessels positioned below the surface of a wave medium and open to the wave medium at the top with a proportion of the top edge protruding through the wave medium.

5. A device for converting wave energy into rotational mechanical energy called a wave amplifier turbine, comprising:
(a) a wave amplifier vessel comprising a top, a bottom, and two forward angled vertical side walls open at the vertex;
(b) a ramp attached to front of said wave amplifier vessel;
(c) a hollow buoyant door hinged between the ramp and said wave amplifier vessel;
(d) and a vertical rotating turbine at the vertex of the vertical walls.

6. A method for converting wave energy into electrical energy comprising:
(a) a plurality of wave catcher wheels of claim 1 connected by means to
(b) a transmission that spins;
(c) a flywheel axle which turns;
(d) an electrical generator that provides electrical energy to,
(e) a transformer and electrical conditioning unit to provide electricity to an end application;
(f) a plurality of pressure differential turbines of claim 3 rotating
(g) said freewheel axle connected to said transmission and
(h) the wave amplifier turbine of claim 5 turning said freewheel axle.

7. A device for converting wave energy into electrical energy comprising:
(a) a plurality of wave catcher wheels of claim 1 connected by means to
(b) a transmission that spins;
(c) a flywheel which turns;
(d) an electrical generator that provides electrical energy to,
(e) a transformer and electrical conditioning unit to provide electricity to an end application;
(f) a plurality of pressure differential turbines of claim 3 rotating
(g) a freewheel axle connected to said transmission and
(h) the wave amplifier turbine of claim 5 turning said freewheel axle
(i) a wind turbine connected by means to said transmission;
(j) a water current turbine connected by means to said freewheel axle and;
(k) a photovoltaic surface providing power to said transformer and electrical conditioning unit.
